(19) United States
(12) Patent Application Publication
(10) Pub. No.: US 2010/0241588 A1
(43) Pub. Date: Sep. 23, 2010

(54) SYSTEM AND METHOD FOR DETERMINING CONFIDENCE LEVELS FOR A MARKET DEPTH IN A COMMODITIES MARKET

(76) Inventor: Andrew Busby, Aurora, IL (US)

Correspondence Address: MCGUIREWOODS, LLP, 1750 TYSONS BLVD, SUITE 1800, MCLEAN, VA, 22102, US

(21) Appl. No.: 12/724,740

(22) Filed: Mar. 16, 2010

Related U.S. Application Data
(60) Provisional application No. 61/160,851, filed on Mar. 17, 2009.

(51) Int. Cl. G06Q 40/00

(52) U.S. Cl. 705/36 R

(57) ABSTRACT

A system and method are provided for providing improved market depth information for traders in exchanges such as a commodity exchange, for example. By adding a confidence rating or quality data to the depth information, the invention provides more useful depth information that should make it much easier for traders to see what is really going on in a market, such as which orders really are working with an intention to be filled. The confidence rating or quality data also may reduce the influence of automated tools on the market place. The confidence ratings may be based on historic behavior patterns of traders or accounts so that a history may be maintained for each trader or account and used to create an aggregated confidence rating for projected bid and offer price levels on a known bid volume showing the likelihood that any order may be filled, or to what degree.

### CROSS REFERENCE TO RELATED APPLICATIONS

This application claims benefit of U.S. Provisional Application No. 61/160,851, filed on Mar. 17, 2009, entitled SYSTEM AND METHOD FOR DETERMINING CONFIDENCE LEVELS FOR A MARKET DEPTH IN A COMMODITIES MARKET, the disclosure of which is incorporated by reference herein in its entirety.

### FIELD OF THE INVENTION

The invention generally relates to a system and method for determining confidence levels for a market depth in a marketplace, and more particularly, to a system and method for determining confidence levels for a market depth in a market such as a commodities market to provide to traders a higher level of confidence related to the probability that orders may be fulfilled.

### BACKGROUND OF THE INVENTION

In trading exchange environments such as a commodities marketplace, the ability of traders and/or account holders to accurately see depth of market information is typically not possible and/or reliable (e.g., due to some orders or parts of orders being hidden at the exchange, such as icebergs or stop orders, spreaders and other automated tools moving orders around frequently, people “slinging in” 1000 lot orders to mess with the matching algorithms, etc). Confidence of order fulfillment is typically among the more elusive aspects of a computerized market system.

Today, exchange systems provide a substantial amount of information including price and volume for specific markets, however, there is little aggregated information related to the level of confidence that a particular order or orders might have in being fulfilled. On the whole, information made available today by exchanges (commodity, stock, futures, etc.) is to a significant degree meaningless information in relation to confidence of order fulfillment.

Moreover, in response to the increase in automated trading tools, several exchanges are continually trying to increase the amount of market depth information that is available and how quickly it is distributed. They are also calculating implied prices from outright months into various strategies, and from strategies into the outright months. This adds yet more information of dubious quality to the market depth, especially when multiple levels of implied prices are generated using volume off the market, which may not be of much use to begin with.

On the whole, the increasing quantity of information, and its declining transparency and usefulness, tends to lead to a proposition that a better way of dealing with this information may be possible. Ideally, a better technique that reduces the effect of traders trying to manipulate the market may also reduce the effect of automated trading tools, thereby providing better quality of information about the state of the market to market participants.

### SUMMARY OF THE INVENTION

The invention satisfies the foregoing needs and avoids the drawbacks and limitations and frustrations of the prior art, and provides a better, more timely and effective process of communication to convey market information, schedule and coordinate events by utilizing an on-line network or Internet-based application.

In one aspect, a computer implemented method for determining confidence levels for market depth in a commodities market system is provided, the method includes computer instructions embedded in a computer storage medium and configured to perform the steps of tracking one or more orders associated with at least one trader of a plurality of traders and generating historical trade information, the historical trade information including at least one of: trade information for each order, trade information for an account, trade information for a trader, and statistics for each order, computing a confidence value for the at least one trader of the plurality of traders based on the historical trade information, computing a confidence rating for a particular market based at least in part on the computed confidence value for the at least one trader and broadcasting the confidence rating for the particular market to the plurality of traders in the commodities market system for providing improved market depth information, wherein each step is performed by a computer platform.

In another aspect, a computer implemented method for determining confidence levels for market depth in a commodities market system is provided, the method including computer instructions embedded in a computer storage medium and configured to perform the steps of receiving confidence information generated based on tracked one or more orders associated with at least one trader of a plurality of traders and based on generated historical trade information, the historical trade information including at least one of: trade information for each order, trade information for an account, trade information for a trader, and statistics for each order and displaying a confidence rating for a particular market based on the confidence information for proving improved market depth information to a trader, wherein the receiving and displaying are performed at a trader access device.

In another aspect, a computer program product embedded in a readable computer storage medium, the computer program product comprising computer instructions that when executed perform the steps of tracking one or more orders associated with at least one trader of a plurality of traders and generating historical trade information including at least one of: trade information for each order, trade information for an account, trade information for a trader, and statistics for each order, computing a confidence value for the at least one trader of the plurality of traders based on the historical trade information, computing a confidence rating for a particular market based at least in part on the computed confidence value for the at least one trader and broadcasting the confidence rating for the particular market to the plurality of traders in an exchange system for providing improved market depth information.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is an exemplary and simplified block diagram of an exchange environment configured according to principles of the invention;

FIG. 2 is an exemplary graphical user interface (GUI) of a typical contract window for displaying received inputs from a trader and for displaying received confidence ratings or quality data for markets, configured according to principals of the invention;

FIG. 3 is a flow diagram of an embodiment of a process, the steps performed according to principles of the invention; and

FIG. 4 is a flow diagram of an embodiment of a process, the steps performed according to principles of the invention.

### DETAILED DESCRIPTION OF EMBODIMENTS OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

Markets such as futures markets have seen huge increases in trading volume and in orders quoted over the last few years. In the busiest markets there are now several times the number of updates to quoted depth than there were as little as 2 or 3 years ago. Many of these updates may be due to automated trading tools such as “auto-spreaders” that may be continuously entering, revising and cancelling orders in response to changing prices in order to try and obtain a specific price differential between multiple markets. A number of these tools being run by different traders may cause literally hundreds of order updates per second in some contracts. These orders may be working at the best bid or offer price, or may be off the market. Many of these orders will never actually fill.

In quiet markets, especially overnight, some professional traders may put in larger volume orders, or multiple orders off the market to try and make it look like there are lots of traders wanting to buy or sell a particular market. Traders may use the “depth” displayed to gauge support for a market (more buyers than sellers, etc.) or simply to get a “feel” (or a perception) for where the market is likely to go based on that depth. Hence, some traders may enter orders to manipulate that “feeling” in order to encourage the market to move in one direction or another, sometimes the intention may be simply to try and nudge another trader into taking the manipulator's existing working orders rather than having to pay a higher price or get a lower price for them. Then, those orders entered to manipulate that market “feel” may be removed before they could get filled.

Several exchanges (e.g., Chicago Mercantile Exchange (CME), IntercontinentalExchangc (ICE)) support Iceberg or MaxShow order types which allow traders to enter a large order but have it displayed to the market in small increments only. For example, a 100 lot order could be submitted with a MaxShow of 10 which means that only 10 will appear in the market depth that is shown to all other traders. Once those 10 are filled then another 10 are made active by the exchange and so on until all 100 have been filled. Not being able to see these complete orders makes it very hard for other traders to see what is actually working in the market place.

Additionally, some exchanges run different order matching algorithms on different contracts. The most common of these algorithms is the simple FIFO approach where an incoming order will match against the oldest order submitted at a given price, and then with the next oldest and so on until the new order volume is completely matched. With this scenario, traders want to get their working orders into market first so that they get filled first. Other algorithms match orders proportionally across all the orders working at that price. These proportions are based in part upon the size of the order, so a trader with a 1000 lot order may be more likely to get a fill than a trader with a 1 or 10 lot order even if he submitted that 1000 lot order long after the other traders submitted theirs. Due to the fact that the trader may, in many cases, only get small pieces of their 1000 lot order filled at a time, they may have plenty of opportunity to still remove the rest of that order once they get the fills they actually wanted. For example, the trader may only want 100 lots filled, but enters a 1000 lot order in order to take advantage of the matching algorithm to get those 100 fills ahead of other traders who are unable to enter large orders due to risk limits, or other factors. These large orders may also show up in the depth and give a misleading impression of orders that genuinely want or are intended to be filled. With the majority of exchanges it is not possible for a trader's frontend to determine accurately whether a 1000 lot volume in the depth is a single order, or the sum of 100 orders from many different traders. Hence, market participants are left guessing as to what is actually there and how long it might stay there.

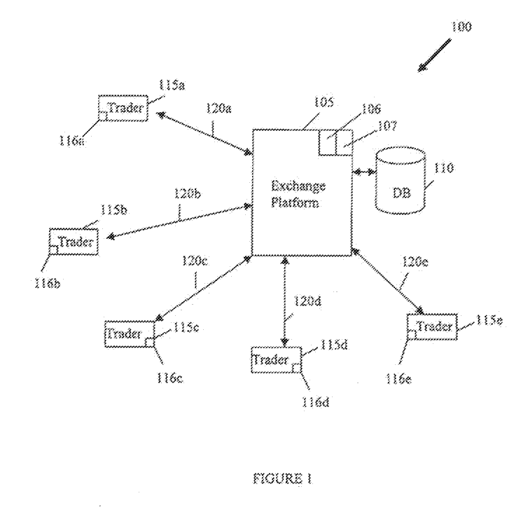

FIG. 1 is an exemplary and simplified block diagram of an exchange environment, configured according to principles of the invention, generally denoted by reference numeral 100. The exchange environment may include a computerized exchange platform 105, which could be one or more computers for controlling, maintaining and processing an electronic exchange marketplace, including but not limited to receiving orders, fulfilling orders and confirming orders, according to exchange rules. The exchange platform 105 may also be configured to execute the processes performed according to principles of the invention described herein. The platform 105 may be communicative with one or more databases 110 for maintaining account, user, trader and market information, among other information. A plurality of user or trader access devices 115a-115e may be utilized to access the exchange 105 via communication pathways 120a-120e, which might be a network access facility, or dedicated data links, for example. The trader access devices 115a-115e may be a computer type platform such as a personal computer, a personalized handheld computerized device, or the like. The overall architecture of the exchange environment 100 may include client server architectures, peer-to-peer architectures, and/or may utilize wireless or wired network interconnectivity, or combinations thereof.

The exchange platform 105 may include a historical trader behavior tracking module 106 that monitors trader (or account) trading patterns and may maintain the historical behavior patterns in storage such as database 110. In alternate configurations, as a skilled artisan would be familiar, the historic tracking module 106 might reside in other external computer platforms with appropriate communication links to the exchange platform 105. The behavior patterns, generally referred to as behavior statistics, may include nearly any information related to each trader or account associated with the exchange including but not limited to: order and trade dates, times, amounts, prices, percentage(s) of filled orders, cancellation rates, order alterations, fulfillment rates, and the like. A confidence rating module 107 configured to generate a confidence rating and/or quality information for each trader or account based on historical behavior statistics may be provided, and may be maintained by the behavior tracking module 106. The confidence rating is described more fully below.

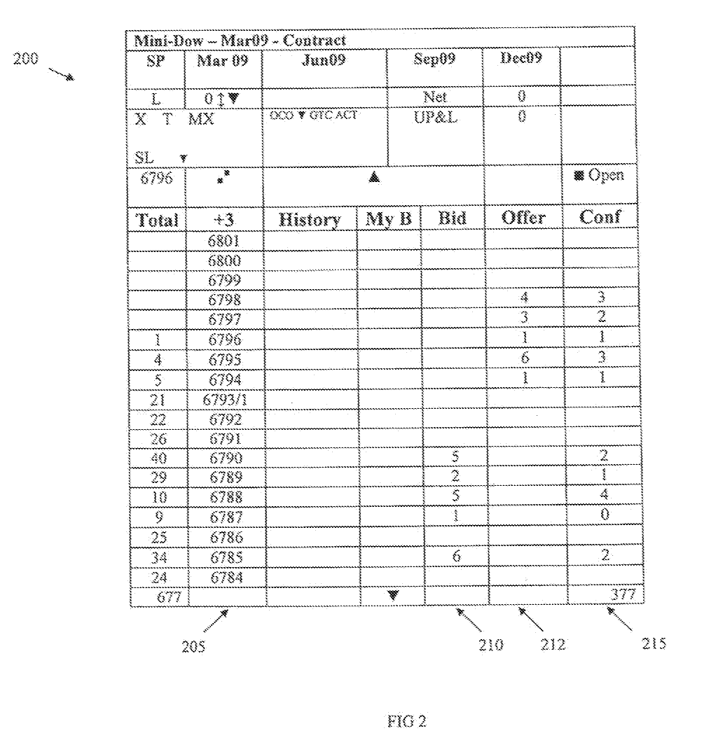

Moreover, each trader access device 115a-115e may include a software component 116a-116e executing in or on behalf of the respective trader access device 115a-115e and may be configured to accept user input and to control a graphical user interface (GUI) display including displaying the confidence ratings information (or quality information), described more fully below, more particularly in relation to FIG. 2.

As indicated already, prior to the invention, exchanges typically only published the aggregate depth information based on the orders entered by market participants. However, by adding a confidence rating or quality data to the depth information, the invention provides, at least in part, more useful depth information that should make it much easier for traders to see what is really going on in a market, such as which orders really are working with an intention to be filled. The confidence rating or quality data also may reduce the influence of automated tools on the market place, as much of the automated tools' volume typically would have low confidence values.

As a result, the features provided by the invention may significantly provide better quality information that should allow traders to make better decisions and, as a result, either make more money or lose less money. This may also improve overall operations of a marketplace.

In one aspect, the invention generally includes providing a capability to apply “trader ratings” to traders in a commodities market (or other type of marketplace such as a stock, bond, or futures market) automatically based on their trading behavior over a period of time. These ratings might be thought of in an analogous way to merchant ratings on eBay® or Amazon® and similar online marketplaces. But instead of people rating them, it may be done automatically based on statistics of the trader's order history. These ratings may be applied to orders entered by those traders automatically and broadcast as part of the market depth information from the exchange to market participants.

The rating concept may include applying a “quality” or “confidence” rating to the order which, when combined with the other orders from other traders in that market, would produce overall depth information including not only price and volume (as is currently provided prior to the invention), but also these new “quality” or “confidence” ratings as well. A trader's display may display this information in various ways, including but not limited to, a simple “star” rating (e.g., display 3 of 5 stars next to the depth item), or a confidence range (e.g., instead of showing 100 lots in the depth, a range of 30-100 might be displayed based on confidence ratings).

FIG. 2 is an exemplary graphical user interface (GUI) of a typical contract window for displaying received inputs from a trader and for displaying received confidence ratings or quality data for markets configured according to principals of the invention, generally denoted by reference numeral 200. The GUI 200 may be generated at any of the trader access devices 115a-115e and reflect trader input selections and/or display received information including confidence ratings or quality data from the exchange platform 105. The GUI 200 includes several fields. Price information, shown in relation to the column labeled 205, shows exemplary prices from 6784 to 6801. The bid volumes may be seen in relation to the column labeled 210, and offer volume may be seen in relation to the column labeled 212. For example, each of the bid volumes at 6785, 6787-6790 and each of the offer volumes at 6794-6798, would have their own associated confidence rating shown in relation to the column labeled 215 (i.e., “Confidence Rating” column). That rating may, for example, indicate that out of the 5 bid @ 6790, only 2 are expected to be filled before traders cancel the others, but the 5 bid @ 6788 may get a confidence rating indicating 4 are likely to be filled.

This confidence rating or confidence range data may be based on the historical behavior of a trader or account over time. It may include many factors, the more likely including “average fill volume per order versus average order size,” “average number of revisions per order,” “average percentage of order size filled” and “average time working for an order.” In one aspect, the invention may include an ability to provide information indicating that if, for example, a trader enters a 100 lot into a market, then based on history, it may be that only 10 of them might be expected to be filled. This may allow a front-end part (typically a software component), configured according to principles of the invention, to display this as a confidence value rather than simply displaying “100.” Other market participants may also see that there are 100 lots available, but in all likelihood only 10 of them will be there when it trades, or that there is only a 10% chance that it will trade, etc.

If multiple traders and/or multiple orders are involved then the computation may become more complex. For example, Trader A enters a 50 lot and has an average fill per order of 40 lots, Trader B enters a 100 lot and has an average fill of 10 lots, Trader C enters a 5 lot order with an average fill of 3. Combined, that gives 155 lots total volume and average fills of 55 lots. Therefore, for this example, the information broadcast by the exchange platform 105 to the traders' access device 115a-115e may include 155 lots, with a confidence of 55 lots.

Depending on the types of statistics or analysis utilized in embodiments, the 55 lot depth value may be more realistic in the market than the 155 lot value. If an auto-spreader tool is continuously working 20 lots just off the best bid and offer, but only gets filled very rarely, then the confidence of that volume may be less than 1. This should make it easier to spot the “real depth” in the market entered by real traders. Automated tools tend to follow where the market is going, or simply react to what the market is doing with preset behavior, so eliminating some of that volume from the market depth may help traders determine what is really “going on.”

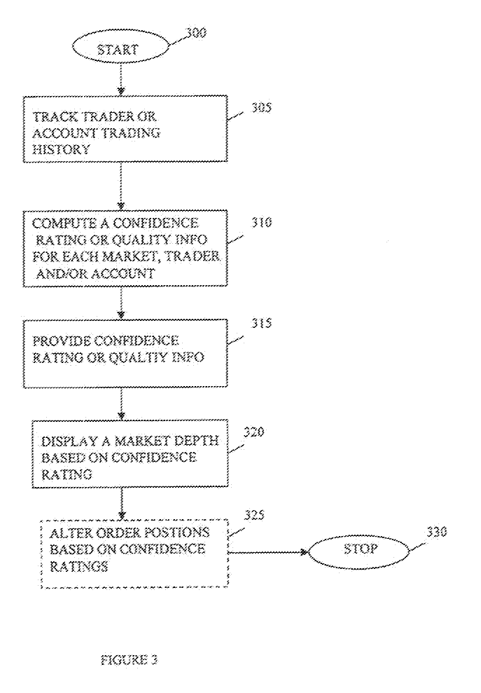

FIG. 3 is a flow diagram of an embodiment of a process performed according to principles of the invention, starting at step 300. All flow diagrams herein may also represent a block diagram of components for performing the steps thereof. The components may be software and/or hardware components or combinations thereof that, when executed, perform the respective step. The components may include software stored on computer storage medium configured and when read and executed on appropriate computer platforms (such as shown in relation to FIG. 1, for example) perform the respective step. The storage medium may include memories, disks, CDs, DVDs, hard drives, personal hand held computing devices, and the like.

At step 305, trading behavior patterns and history may be tracked for each trader or subset of traders associated with an exchange such as a commodity exchange. Alternatively, or in addition, the tracked information may be acquired for each account or subset of accounts associated with such an exchange. Statistics associated with each trader or account (or an order) may be computed on a pre-defined interval such as every day, for example. Moreover, as markets may trade differently at different times of a day, statistics may be generated either for specific time ranges and/or for different market conditions (e.g., busy vs. quiet periods) and applying those statistics appropriately based on the time of day or market conditions.

At step 310, a confidence rating may be computed for a market (e.g., a particular commodity) for various offer and bid prices in view of a lot size. The confidence rating may reflect the degree of confidence that any particular order may be fulfilled based at least in part on the aggregated confidence of all or portions of participating market makers. Each market maker may have an individual confidence rating component computed based on historical behavior and/or statistics.

At step 315, the confidence rating for each market, perhaps associated with each offer and bid price, and/or associated with each offer and bid volume, may be provided to the exchange participants such as traders or accounts. This information may be provided as a communication or a broadcast to participants. A projected fill volume may be calculated and provided to participants based on the confidence rating for any market order for one or more markets and may be displayed such as shown in relation to FIG. 2.

At step 320, the confidence rating may be displayed at trader access devices (e.g., devices 115a-115e) perhaps as part of, or related to, market depth information. At optional step 325, a market order or sets of orders may be altered or revised, either manually or automatically, based on the market depth information that at least in part includes the provided confidence rating(s). At step 330, the process may end.

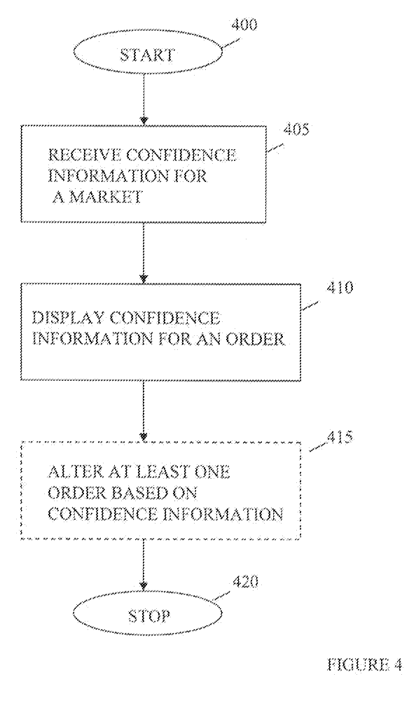

FIG. 4 is a flow diagram of an embodiment of a process performed according to principles of the invention, starting at step 400. At step 405, confidence information related to a market, trader, account, one or more orders may be received at a trader access device such as trader access device 115a-115e. The confidence information may be a result of analysis of historical trading patterns for a particular market. It may also be a result of an aggregation of historical data for one or more traders, orders, or accounts. At step 410, the confidence information may be displayed as a confidence rating for a trader and/or a market. The confidence information or confidence rating may be associated with a market depth display, an inside market display and/or a price level (bid or ask). The confidence information and the confidence rating may be the same data, but not necessarily. The confidence rating may be displayed as, but not limited to, a numeric display, an alphanumeric display, color coded display, or as a graph type display. At optional step 415, based on the confidence information or confidence rating, one or more existing orders may be altered either manually or automatically. Moreover, based on the confidence information or confidence rating, newly submitted orders may be placed, or existing orders cancelled, based on updated or revised confidence information or updated confidence ratings such as received from an exchange, according to principles of the invention. At step 420, the process may end.

The above examples may be somewhat simplified for clarity, however, it is contemplated that more complex statistics and analysis may be utilized, such as the use of standard deviations to give a confidence range of the data provided, in some instances adding weightings for exchange members versus customers, registered market makers, time of day the orders were entered/filled, how close the orders were to the best bid or offer at the time, and so forth. It is envisioned that a range of data may be provided, possibly including but not limited to: the actual depth volume (e.g., 155 in the above scenario), expected fill volume (e.g., 55 in the above scenario), standard deviation or confidence range (allowing a range of 55+/−stdev, 55+/−(2*stdev) to be generated).

Employing statistical analysis of the traders' (or accounts') behavior patterns may provide useful and more accurate information of market conditions. For example (for illustration only and not limiting), if for a particular trader an average fill percentage is 20% and knowing a standard deviation, perhaps 5, may result in an awareness that the trader orders have been filled between 15% and 25%, and that 97% were filled between 10% and 30%. This may convey that it is “rare” for this particular trader's orders to be filled either <10% of their volume or >30% of their volume. So, illustratively, if this trader places a 100 lot order, it is almost not worth displaying more than 30 of them to the rest of the market as they are so unlikely to be filled.

In many situations, the exchange may be the only entity that knows to which traders (or accounts) all the orders in the market belong to (i.e., which trader or account is responsible for which orders). Therefore, the exchange may be a likely candidate for implementing the system and processes of the invention such as calculating, applying and conveying the confidence ratings or quality data. Depending on the architecture that a specific exchange employs, an example of how this may be accomplished may include:
When an order is entered, the system may look up historical statistics (or other analysis data) on the trader's (or account's) behavior for the last month (or other pre-determined period of time) on this contract and strategy type. This presupposes that the trader's behavior is being tracked.
Based on those statistics and the details of the newly submitted order a confidence value or volume range may be applied to the order.
This order information and its associated confidence data may be merged with the other orders already working in the market at that price (if any) and the updated market depth information, including both merged order volumes and merged confidence or range data is broadcast out to market participants.
At end of the day, or possibly as each order is entered/revised/filled or cancelled, the system may update the historical statistics or analysis of each trader (or account).
In some embodiments, this rating information on individual traders may be known only to the exchange and, hence, the exchange may not allow a market participant to identify another trader from the information.

In one aspect, a computer implemented method for determining confidence levels for market depth in a commodities market system may be provided. The method may include computer instructions embedded in a computer storage medium and configured to perform the steps of tracking one or more orders associated with at least one trader of a plurality of traders and maintaining historical trade information for each order, computing a confidence value for the at least one trader of the plurality of traders based on the historical trade information, computing a confidence rating for a particular market based at least in part on the computed confidence value for the at least one trader and broadcasting the confidence rating for the particular market to the plurality of traders in the commodities market system to provide market depth information. In one aspect, the computing a confidence rating step may be determined at least in part based on the computed confidence value associated with each trader having an order submitted for the particular market. In another aspect, the confidence rating may be computed at least in part by combining the computed confidence value of all the plurality of traders having open orders for the particular market. In yet another aspect, the computing a confidence rating step may include computing a lot depth and the broadcasting step broadcasts the lot depth. In one embodiment the historical information includes at least any one of: average fill volume per order versus average order size, average percentage of order size filled, average number of revisions per order and average time working for an order. In one embodiment the at least one trader is identified by an account.

In another aspect, a computer implemented method may be provided for determining confidence levels for market depth in a market system that includes computer instructions embedded in a computer storage medium and configured to perform the steps of tracking one or more orders associated with at least one account of a plurality of accounts and maintaining historical trade information for each order or statistics for each order, computing a confidence value for the at least one account of the plurality of accounts based on the historical trade information or statistics, computing a confidence rating for a particular market based at least in part on the computed confidence value for the at least one account and providing the confidence rating for the particular market to a plurality of traders in the commodities market system to provide market depth information.

In another aspect, a system for providing market depth information includes a market exchange computing platform in communication with a plurality of traders to facilitate electronic market exchange operations, a behavior tracking module executing in the market exchange computing platform and configured to track trader behavior or account behavior over time to produce historical behavior statistics for each trader or account, and a confidence rating module executing in the market exchange computing platform and configured to generate a confidence rating for each trader or account based on historical behavior statistics provided by the behavior tracking module wherein the confidence rating provides a market depth information for a plurality of markets to a plurality of the traders.

Another embodiment may include filtering information on a trader's display, itself based only on the depth information that they see. However, as exchanges do not provide information related to who has entered which order, there is no apparent way to relate multiple orders to each other and no way of building a profile of a traders' past behavior and using that as a guide to future behavior. The best that could be done would be statistical or other analysis on the market behavior as a whole. This may yield useful data but may be analogous to rating eBay® merchants based on what they sell, not on their own actions (i.e., if 1000 marble figurines were sold on eBay® by an unknown number of merchants, and the average rating of those 1000 transactions was 3 stars and there are other marble figurines for sale now and all one knows is the 3 star average rating, then there is uncertainty of what level of confidence might a user have in picking one merchant over another). One trader might be dealing with a 1 star or 5 star merchant but the trader may not necessarily know because that information may not be available. On average one would expect a 3 star service from the merchant, but the trader could make a much better decision on whether to deal with a given merchant or not if the trader knew they were either a 1 star, 3 star or 5 star merchant based only on their own transactions.

In another aspect, it is contemplated that the analysis and confidence data generation processes described herein may performed at least in part using neural net, artificial intelligence or other pattern matching techniques. Moreover, since markets may trade with different behaviors at different times of a day, statistics described herein may be generated either for specific time period or ranges, and/or for different market conditions (e.g., busy vs. quiet periods). The statistics may be applied appropriately based on the time of day or market conditions.

While the invention has been described in terms of embodiments, those skilled in the art will recognize that the invention can be practiced with modifications and in the spirit and scope of the appended claims.

What is claimed:

1. A computer implemented method for determining confidence levels for market depth in a commodities market system, the method including computer instructions embedded in a computer storage medium and configured to perform the steps of:
tracking one or more orders associated with at least one trader of a plurality of traders and generating historical trade information, the historical trade information including at least one of: trade information for each order, trade information for an account, trade information for a trader, and statistics for each order;
computing a confidence value for the at least one trader of the plurality of traders based on the historical trade information;
computing a confidence rating for a particular market based at least in part on the computed confidence value for the at least one trader; and
broadcasting the confidence rating for the particular market to the plurality of traders in the commodities market system for providing improved market depth information,
wherein each step is performed by a computer platform.

2. The computer-implemented method of claim 1, wherein the step of computing a confidence rating is determined at least in part based on the computed confidence value associated with each trader having an order submitted for the particular market.

3. The computer-implemented method of claim 2, wherein the confidence rating is computed at least in part by combining the computed confidence value of all the plurality of traders having open orders for the particular market.

4. The computer-implemented method of claim 2, wherein the computing a confidence rating step includes computing a lot depth and the broadcasting step broadcasts the lot depth.

5. The computer-implemented method of claim 1, wherein the historical information includes at least any one of: average percentage of order size filled, average number of revisions per order and average time working for an order.

6. The computer-implemented method of claim 1, wherein the at least one trader is identified by an account.

7. The computer-implemented method of claim 1, wherein the confidence rating is computed individually for a plurality of bids and a plurality of asks in a particular market.

8. A computer implemented method for determining confidence levels for market depth in a commodities market system, the method comprising computer instructions embedded in a computer storage medium and configured to perform the steps of:
receiving confidence information generated based on tracked one or more orders associated with at least one trader of a plurality of traders and based on generated historical trade information, the historical trade information including at least one of: trade information for each order, trade information for an account, trade information for a trader, and statistics for each order; and
displaying a confidence rating for a particular market based on the confidence information for proving improved market depth information to a trader, wherein the receiving and displaying are performed at a trader access device.

9. The computer implemented method of claim 8, wherein the displaying displays the confidence rating associated with a pending order.

10. The computer implemented method of claim 8, wherein the displaying displays a market depth based on the confidence information.

11. The method of claim 8, further comprising altering at least one order based on the confidence information.

12. The method of claim 11, wherein the altering automatically alters the at least one order.

13. A computer program product embedded in a readable computer storage medium, the computer program product comprising computer instructions that when executed perform the following steps:
tracking one or more orders associated with at least one trader of a plurality of traders and generating historical trade information including at least one of: trade information for each order, trade information for an account, trade information for a trader, and statistics for each order;
computing a confidence value for the at least one trader of the plurality of traders based on the historical trade information;
computing a confidence rating for a particular market based at least in part on the computed confidence value for the at least one trader; and
broadcasting the confidence rating for the particular market to the plurality of traders in an exchange system for providing improved market depth information.

14. The computer program product of claim 13, wherein the step of computing a confidence rating is determined at least in part based on the computed confidence value associated with each trader having an order submitted for the particular market.

15. The computer program product of claim 13, wherein the confidence rating is computed at least in part by combining the computed confidence value of all the plurality of traders having open orders for the particular market.

16. The computer program product of claim 13, wherein the computing a confidence rating step includes computing a lot depth and the broadcasting step broadcasts the lot depth.

17. The computer program product of claim 13, wherein the historical information includes at least any one of: average percentage of order size filled, average number of revisions per order and average time working for an order.

18. The computer program product of claim 13, wherein the at least one trader is identified by an account.

19. The computer program product of claim 13, wherein the confidence rating is computed individually for a plurality of bids and a plurality of asks in a particular market.
